(19) United States
(12) Patent Application Publication
(10) Pub. No.: US 2002/0120049 A1
(43) Pub. Date: Aug. 29, 2002

(54) Extruded nanocomposite moulded part comprising at least a polycondensate and a nano-filler and a process for its production

(75) Inventors: Martin A. Van Es, Brunssum (NL); Paulus A.M. Steeman, Geleen (NL); Patrick E.L. Voets, Born (NL)

Correspondence Address: Pillsbury Madison & Sutro LLP, Intellectual Property Group, East Tower, Ninth Floor, 1100 New York Avenue, N.W., Washington, DC, 20005-3918, US

(73) Assignee: DSM N.V., Heerlen (NL)

(21) Appl. No.: 10/077,772

(22) Filed: Feb. 20, 2002

Related U.S. Application Data
(63) Continuation of application No. PCT/NL00/00587, filed on Aug. 24, 2000.

(30) Foreign Application Priority Data
Sep. 3, 1999 (NL) 1012974

(51) Int. Cl. C08K 3/34

(52) U.S. Cl. 524/445

(57) ABSTRACT

The invention relates to an extruded moulded part comprising at least a polycondensate with a melt strength such that the polycondensate is not suitable for extrusion applications per se and a nano-filler, and a process for its production. The major advantage of the extruded moulded part and the process according to the invention is that extruded moulded parts containing polycondensate grades with both high and low viscosities are available. It is for example possible to use polyamides and polyesters that have not been after-condensed in the extruded moulded part according to the invention. Preferably, the extruded moulded part according to the invention contains a polyamide with a relative viscosity of less than 4.3, determined in a 1 % solution of the polyamide in m-cresol at 25° C. The invention also relates to a process for increasing the melt strength of a polycondensate composition that contains at least a polycondensate by adding an amount of nano-filler to the composition.

### CROSS-REFERENCE TO RELATED APPLICATIONS

This is a Continuation of International Application No. PCT/NL00/00587 filed Aug. 24, 2000 which designated the U.S. and was published in the English language. The contents of this PCT application are incorporated in their entirety by reference.

The invention relates to an extruded moulded part comprising at least a polycondensate and a process for its production.

Such an extruded moulded part is commonly known, for example from Kunststoff Handbuch, Becker et al., Carl Hanser Verlagf München, 1990.

In the context of this application an ‘extruded moulded part’ is understood to be any object that can be obtained by means of extrusion, in particular a film, for example a flat film or a tubular film, a foam, a thin-walled object, for example a bottle, a tube or a hose, a thick-walled object, for example a moulded profile, tube or plate, a fibre, a monofilament or a thread, for example cable insulation. ‘Film’ is understood to be a material with a thickness that is small in comparison with the length and/or width of the material, its maximum thickness being about 250 micrometers. A ‘thin-walled object’ is understood to be an object at least part of which consists of a material with a thickness of more than about 250 micrometers and less than about 1 mm. A ‘thick-walled object’ is understood to be an object at least part of which consists of a material with a thickness of more than about 1 mm.

‘Extrusion’ is understood to be a process in which a moulded part is formed from the melt and which comprises at least one step in which a cooling melt is formed into a moulded part, for example a melt-drawing step.

The disadvantage of the extruded moulded part according to the state of the art is that the polycondensate has a high melt viscosity (MV), in particular an MV that is higher than the MV of a polycondensate that forms part of moulded parts obtained with the aid of the injection-moulding technique. This greatly limits the choice of the polycondensate to be used. It is commonly known to a person skilled in the art that, for the production of an extruded moulded part, the polycondensate composition from which the moulded part is produced must have a good melt processability. This is obtained by choosing a polycondensate with a high MV, for example a polyamide with a relative viscosity (RV) of 4.0 or more as determined in a 1% solution of the polyamide in m-cresol at 25° C. The use of a polycondensate with a low MV leads for example to fracture, for example during the production of films, or for example even to the impossibility of extruding films and thin-walled moulded parts.

The aim of the present invention is to provide an extruded moulded part comprising at least a polycondensate with such a melt processability that the polycondensate is not suitable for extrusion applications per se, and a process for obtaining it.

The inventors have now surprisingly found that a moulded part can be extruded, which comprises at least a polycondensate with such a melt processability that the polycondensate is not suitable for extrusion applications per se and a nano-filler. It has surprisingly been found that such a composition has such a high melt strength that a moulded part can be extruded from said composition. Said composition is known per se, for example from EP-A2-605,005 ((Unitika), but not for extrusion applications.

From EP-A1-810,260 (BAYER A. G.) is known a film containing polyamide 6 prepared from caprolactam in the presence of a finely dispersed fluoro-mica mineral. According to EP-A1-810,260, such a film has a low gas permeability, while other properties, such as gloss, transparency and ductility, do not change appreciably relative to a film that does not contain the finely dispersed fluoro-mica mineral. The polyamide has a high RV of 4.3, determined in a 1% solution of the polyamide in m-cresol at 25° C.

The great advantage of the extruded moulded part according to the invention is that extruded moulded parts containing polycondensate grades with both high and low viscosities are now available. For example, polyamides and polyesters that have not been after-condensed can be used in the extruded moulded part according to the invention.

Another advantage of the extruded moulded part according to the invention is that less energy is needed during the compounding of the nanocomposite composition, and that the composition's thin processability is better. This leads to for example thinner films. Another advantage is that one grade of polycondensate can be used both for extrusion and for injection-moulding applications by adding or not adding the nano-filler.

As an additional advantage the inventors found that the surface of the moulded parts according to the invention showed a larger gloss and transparency, films according to the invention showed no contraction and the films according to the invention showed a lower gas permeability and the films could be produced with much greater blow-up ratios in film blowing.

More in general, the inventors have found that the addition of an amount of nano-filler to polycondensate leads to a drastic increase in the melt strength of the resulting composition. The invention hence also relates to a process for increasing the melt strength of a polycondensate composition that contains at least a polycondensate by adding an amount of nano-filler, preferably by adding 0.1-10 wt. % nano-filler, more preferably 0.2-7.5 wt. %, relative to the polycondensate.

Any polymer known to a person skilled in the art can be chosen as the polycondensate, in particular polyamide, polyester, polyether ester, polycarbonate, polyester amide and blends and copolymers thereof.

In particular, a polyamide or polyester is chosen.

Preferably the polycondensate according to the invention is a polyamide with a relative viscosity of less than 4.3 as determined in a 1% solution of the polyamide in m-cresol at 25° C.

Any polymer with acid-amide bonds (—CONH—) between the repeating units can be chosen as the polyamide, more in particular polyamides and copolyamides obtained from ε-caprolactam, 6-aminocaproic acid, w-enantholactam, 7-aminoheptanoic acid, 11-aminodecanoic acid, 9-aminononanoic acid, α-pyrrolidone and α-piperidone; polymers and copolymers obtained in the polycondensation of diamines, for example hexamethylene diamine, nonamethylene diamine, undecamethylene diamine, dodecamethylene diamine and metaxylene diamine, with dicarboxylic acids, for example terephthalic acid, isopthalic acid, adipic acid and sebacic acid; blends of the aforementioned polymers and copolymers. Examples of such polymers are nylon 6, nylon 9, nylon 11, nylon 12, nylon 4,6 and nylon 6,6. Preferably nylon 6 is chosen.

In principle, all the usual polyesters and copolyesters are suitable for use as the polyester. Examples are polyalkylene terephthalates or copolyesters thereof with isophthalic acid, for example polyethylene terephthalate (PET), polybutylene terephthalate (PBT), polyalkylene naphthalates, for example polyethylene naphthalate (PEN), polypropylene naphthalate, polybutylene naphthalate (PBN), polyalkylene dibenzoates, for example polyethylene bibenzoate and copolyesters hereof. Preferably use is made of PET, PBT, PEN or PBN. Also suitable are block copolyesters which, in addition to hard polyester segments from the above group, contain thermoplastic polyesters, soft polyester segments derived from at least one polyether or aliphatic polyester. Examples of such block copolyesters with elastomeric properties are for example described in “Encyclopedia of Polymer Science and Engineering”, Vol. 12, pp. 75 ff. (1988), John Wiley & Sons, and “Thermoplastic Elastomers”, 2nd Ex., chapter 8 (1996), Hauser Verlag, and the references mentioned therein.

As the nano-filler, use can be made of any material known as such to a person skilled in the art. In particular, a ‘nano-filler’ is understood to be a solid substance composed of anisotropic particles with a high aspect ratio, for example layered or fibrous inorganic materials.

A particle's aspect ratio is in the context of this invention understood to be the ratio of an individual particle's largest and smallest dimension. More in particular, the aspect ratio of a plate is the ratio of the length and the average thickness of the plate, and the aspect ratio of a fibre is the ratio of the length and the average diameter of the fibre. Preferably use is made of a solid substance composed of anisotropic particles with a high aspect ratio, said aspect ratio lying between 5 and 10,000, preferably between 10 and 10,000, more preferably between 100 and 10,000.

Suitable layered inorganic materials consist of plates with an average aspect ratio of between 5 and 10,000. The plates then have an average thickness of about 2.5 nm or less, and a maximum thickness of 10 nm, preferably between about 0.4 nm and about 2.5 nm, more preferably between about 0.4 nm and about 2 nm. The average length of the plates is preferably from about 2 nm to 1,000 nm. Examples of suitable layered inorganic materials are phyllosilicates, for example smectic clay minerals, vermiculite clay minerals and micas, and synthetic micas. Examples of suitable smectic clay minerals are montmorillonite, nontronite, beidellite, volkonskoite, hectorite, stevensite, pyroysite, saponite, sauconite, magadiite, bentonite and kenyaite. Preferably montmorillonite is chosen.

The individual fibres in the suitable fibrous inorganic materials have an average aspect ratio of 5 to 10,000. The diameter of the individual fibres is then about 10 nm or less, the maximum diameter being 20 nm, preferably between about 0.5 nm and about 10 nm, more preferably between about 0.5 nm and about 5 nm. The average length of the individual fibres in suitable fibrous inorganic materials is usually about 2,000 nm or less, the maximum length being about 10,000 nm, preferably between about 20 nm and about 200 nm, more preferably between about 40 nm and about 100 nm. Examples of suitable fibrous inorganic materials are imogolite and vanadium oxide.

The amount of nano-filler may be freely chosen; the amount will depend on for example the desired properties of the extruded moulded part to be obtained and on e.g. the polycondensate chosen, the degree of delamination of the nano-filler and the degree of dispersion in the polycondensate. In the context of this application, ‘nano-filler’ is understood to be both the filler as commercially available in an aggregated form and the filler in a deaggregated and delaminated form, as is to be found in the extruded moulded part. The nano-filler has either not been pretreated or modified or it has been pretreated or modified, for example to promote delamination. In the event of complete dispersion and delamination the amount of nano-filler is preferably 0.1-10 wt. %, relative to the polycondensate. Preferably the amount of nano-filler in polyamide is 0.1-10 wt. %, more preferably 0.2-7.5 wt. %, relative to the polyamide. The minimum and maximum amounts can easily be determined by a person skilled in the art because extruded moulded part can hardly be obtained with the composition with amounts below the minimum and above the maximum amounts.

The extruded moulded part according to the invention optionally comprises additives, for example fillers and reinforcing materials, for example glass fibres and silicates, for example talcum, flame retardants, foaming agents, stabilisers, flow-promoting agents and pigments.

The extruded moulded part according to the invention may consist of one or of several layers; in the latter case the other layers may consist of for example polyolefines, for example polyethylene or polyethylene copolymers, for example copolymers obtained from ethylene and (meth)acrylic acid or barrier polymers, for example polyvinylidene chloride or copolymers obtained from ethylene and vinyl alcohol.

The invention also relates to a process for the production of the polycondensate nanocomposite moulded part by means of extrusion, characterised in that the moulded part is extruded from a composition comprising at least a polycondensate with a melt processability such that the polycondensate is not suitable for extrusion applications per se and a nano-filler.

In particular, the known techniques can be used to produce the extruded moulded part according to the invention, for example extrusion, coextrusion, film blowing, profile extrusion, foam extrusion, blow-moulding, deep drawing, calendering and spinning. In the case of film, the extrusion or coextrusion can be effected for example with the aid of the chill-roll technique or by means of film blowing.

The composition with which the extruded moulded part according to the invention can be produced according to the invention can be obtained in various ways known to a person skilled in the art, for example by means of polymerisation of the monomers in the presence of the nano-filler as published in EP-A2-605,005 or by melt-mixing the polycondensate and the nano-filler, for example with the aid of an extruder, for example using the process according to U.S. Pat. No. 5,385,776 (AlliedSignal Inc.). To obtain the desired properties it is important that good dispersion and delamination of the nano-filler take place in the polycondensate.

The extruded moulded part according to the invention can in particular be used for example in the form of a film as a packaging film, for example for wrapping up foodstuffs, for example cheese and sausage.

The invention will now be elucidated with reference to examples without being limited hereto.

### EXAMPLES

### Examples I-VII and Comparative Examples A and B

Polyamide Flat Films

Production of Flat Films

A series of flat films was produced using a Gottfert extruder (type 616) with the following properties: screw diameter 30 mm, length 20×D, film head width 150 mm, extruder temperature 250° C., chill roll temperature 110° C.

Polyamide

Akulon® K123: injection-moulding-grade polyamide 6, relative viscosity of 2.8 (DSM N.V., the Netherlands). Akulon® F132E: film-grade polyamide 6, relative viscosity of 4.0 (DSM N.V., the Netherlands).

Nano-filler

Cloisite 20A (montmorillonite clay, Southern Clay Products, USA), consisting of 60 wt. % silicate and 40 wt. % organic matter (quaternary ammonium salt). The quantities quoted in the tables relate to the silicate content.

The polyamide nanocomposite composition was prepared by melt-mixing the polyamide in an extruder with a polyamide nanocomposite masterbatch containing 80 wt. % nano-filler (silicate).

The results are summarised in Table 1. They show that it is not possible to produce a film using only a polyamide with a low viscosity, whereas a good film can be produced with the composition according to the invention. All the viscosities in Table 1 and the following tables were determined in a 1% solution of polyamide in m-cresol at 25° C.

TABLE 1
Polyamide flat films

| | | | Processing parameters | | |
|---|---|---|---|---|---|
| | Poly- | Nano-filler | Q | v (winding) | |
| Example | amide | (wt. %) | (rpm) | (m/min) | Melt processability |
| A | K123 | 0 | 80 | 20 | no production possible; |
| | | | | | insufficient melt strength |
| I | K123 | 0.1 | 60 | 20 | no production possible; |
| | | | | | insufficient melt strength |
| II | K123 | 0.2 | 60 | 20 | good film |
| III | K123 | 1 | 60 | 20 | good film |
| IV | K123 | 2.5 | 60 | 20 | good film |
| V | K123 | 5 | 60 | 20 | good film |
| VI | K123 | 7.5 | 60 | 20 | inhomogeneous processing |
| | | | | | behaviour; poor film |
| VII | K123 | 10 | 60 | 30 | no production possible; film could |
| | | | | | no longer be drawn |
| B | F132E | 0 | 60 | 20 | good film |

### Example VIII and Comparative Examples C and D

Polyamide Tubular Films

Production of the Tubular Films

A series of tubular films was produced using a Collin (type 130) with the following properties: screw diameter 25 mm, length 20×D, standard universal screw; chill roll dimensions 126×600 mm; rubber roll dimensions 72×600 mm; maximum open loop path 25 mm. Temperature 250° C.; blow-up ratio:3

Polyamide

Akulon® K123: injection-moulding-grade polyamide 6, relative viscosity of 2.8 (DSM N.V., the Netherlands). Akulone® F136E: film-grade polyamide 6, relative viscosity of 4.3 (DSM N.V., the Netherlands).

Nano-filler

Cloisite 20A (montmorillonite clay, Southern Clay Products, USA), consisting of 60 wt. % silicate and 40 wt. % organic matter (quaternary ammonium salt). The quantities quoted in the tables relate to the silicate content.

The polyamide nanocomposite composition was prepared by melt-mixing the polyamide in an extruder with a polyamide nanocomposite masterbatch containing 80 wt. % nano-filler (silicate).

The results are summarised in Table 2. They show that the addition of a small amount of nano-filler to a polyamide with a low viscosity leads to an increase in the melt processability such that a good tubular film could be obtained.

TABLE 2
Polyamide tubular films

| | | Nano-filler | |
|---|---|---|---|
| Example | Polyamide | (wt. %) | Film |
| C | K123 | 0 | no production possible; insufficient |
| | | | viscosity |
| VIII | K123 | 5 | good film; the film becomes |
| | | | increasingly transparent as the |
| | | | blow-up ratio increases (3-4-4.5) |
| D | F136E | 0 | good film |

### Examples IX-XI and Comparative Example E: Polyamide Plate

Production

A series of plates was produced using a Schabenthan with the following properties: head width 150 mm; smooth feed section; extrusion temperature 250° C.; chill roll temperature 40° C.; die width in head 1.9 mm; width of gap between rolls 1 mm; speed 50 rpm.

Polyamide

Akulon® F135C: extrusion-grade polyamide 6, relative viscosity of 4.1 (DSM N.V., the Netherlands).

Nano-filler

Cloisite 20A (montmorillonite clay, Southern Clay Products, USA), consisting of 60 wt. % silicate and 40 wt. % organic matter (quaternary ammonium salt). The quantities quoted in the tables relate to the silicate content.

The polycondensate nanocomposite composition was prepared by melt-mixing the polyamide in an extruder with a masterbatch containing Akulone® K123+5 wt. % nano-filler.

The results are summarised in Table 3. They show that the addition of a small amount of nano-filler to the polyamide led to an increase in the melt processability such as to prevent sagging of the plate. Surprisingly, a better gloss and greater transparency were obtained, too. Sagging of plates during extrusion is a well-known phenomenon that occurs between the injection-moulding die and the first roll. Sagging was prevented by increasing the melt processability.

TABLE 3
Polyamide plates

| | | Nano-filler | |
|---|---|---|---|
| Example | Polyamide | (wt. %) | Plate |
| E | F135C | 0 | Sagging of the plate observed |
| IX | F135C | 0.25 | Less sagging |
| X | F135C | 0.5 | No sagging |
| XI | F135C | 1 | No sagging |

1. Extruded moulded part comprising a polycondensate, chosen form the group comprising polyamide and polyester, with a relative viscosity of at most 2.8, (said relative viscosity being determined in a 1% solution of the polycondensate in m-cresol at 25° C.) , and a nano-filler, chosen from the group of clay mineral and fibrous inorganic material, composed of anisotopic particles with an aspect ratio between 5 and 10,000 and an average length from 2 nm to 1,000 nm in an amount of 0.2-5 wt. % relative to the polycondensate.

2. Extruded moulded part according to claim 1, wherein the polycondensate is a polyamide

3. Extruded moulded part according to claim 1, wherein the nano-filler is a smectic clay mineral.

4. Extruded moulded part according to claim 1, wherein the smectic clay mineral is montmorillonite.

5. Extruded moulded part according to claim 1, wherein the moulded part is a film, a thin-walled object, a thick-walled object, a foam or a fibre.

6. Process for the production of a polycondensate moulded part by means of extrusion, wherein the moulded part is extruded from a composition comprising a polycondensate, chosen from the group consisting of polyamide and polyester, with a viscosity of at most 2.8, (said relative viscosity being determined in a 1% solution of the polycondensate in m-cresol at 25° C.), and a nano-filler, chosen from the group of clay mineral and fibrous inorganic material, composed of anisotopic particles with an aspect ratio between 5 and 10,000 and an average length from 2 nm to 1,000 nm in an amount of 0.2-5 wt. % relative to the polycondensate.

7. Process according to claim 6, wherein the polycondensate is a polyamide.

8. Process according to claim 6, wherein the nano-filler is a smectic clay mineral.

9. Process according to claim 6, wherein the smectic clay mineral is montmorillonite.

10. Process according to claim 6, wherein the process is a film extrusion process.
